(19) United States
(12) Patent Application Publication
(10) Pub. No.: US 2015/0117018 A1
(43) Pub. Date: Apr. 30, 2015

(54) LIGHT-EMITTING DIODE (LED) LAMP BULB

(71) Applicant: Ching-Hui CHEN, Huizhou City (CN)

(72) Inventor: Ching-Hui CHEN, Huizhou City (CN)

(21) Appl. No.: 14/215,009

(22) Filed: Mar. 16, 2014

(30) Foreign Application Priority Data
Oct. 31, 2013 (CN) 201320683067.0
Dec. 10, 2013 (CN) 201320808414.8

(51) Int. Cl. F21K 99/00; F21V 29/00

(52) U.S. Cl. CPC F21K 9/1355; F21V 29/22
USPC 362/294; 362/311.02

(57) ABSTRACT

A light-emitting diode (LED) lamp bulb, comprises a lampshade, a lamp holder and a fixing base, wherein internal threads are formed in the lamp holder; external threads are formed on an outer wall of the fixing base; the fixing base is extended into the lamp holder from an open end of the lamp holder; the fixing base is in threaded connection with the internal threads in the lamp holder through the external threads of the fixing base, or alternatively, viscose glue is coated between the fixing base and the lamp holder and the fixing base is directly adhered to the lamp holder; the lampshade is connected with the open end of the lamp holder; aluminum bases are fixed on the fixing base; and LEDs are disposed on the aluminum bases which are disposed in the lampshade.

### FIELD OF THE INVENTION

The invention relates to a light-emitting diode (LED) lamp bulb, which belongs to the technical field of illumination.

### BACKGROUND OF THE INVENTION

In the prior art, the traditional incandescent lamp utilizes filaments for light emitting, and hence the service life is not stable and the ignition time is usually not more than 500 hours. In addition, a lamp bulb tends to emit heat when used, and hence the power consumption can be large. With the development of the LED technology, LED lamps are more and more widely applied in illumination due to the advantages of low power consumption, low heat productivity, long service life and the like. The LED lamp bulb in the prior art consists of a lamp holder, a lampshade, an aluminum radiator and an LED disposed on a circuit board, wherein one end of the aluminum radiator is connected with the lamp holder and the other end of the aluminum radiator is connected with the circuit board and connected with the lampshade as well; and the circuit board is disposed in the lampshade. The lamp bulb has the defects of large size and high cost as the aluminum radiator occupies a large space. Moreover, as the LED is only oriented downwards, light emitted to the circumference is not bright enough.

### SUMMARY OF THE INVENTION

The technical problem to be solved by the invention is to provide an LED lamp bulb which has the advantages of small size, firm internal structure and simple assembly.

The LED lamp bulb provided by the invention may adopt the technical proposal that:

The invention discloses an LED lamp bulb, which comprises a lampshade, a lamp holder and a fixing base, wherein the shape of the fixing base made of plastics is matched with the inside of the lamp holder; internal threads are formed in the lamp holder; external threads are formed on an outer wall of the fixing base; the fixing base is extended into the lamp holder from an open end of the lamp holder; the fixing base is in threaded connection with the internal threads in the lamp holder through the external threads of the fixing base, or alternatively, viscose glue is coated between the fixing base and the lamp holder and the fixing base is directly adhered to the lamp holder; the lampshade is connected with the open end of the lamp holder; aluminum bases are fixed on the fixing base; and LEDs are disposed on the aluminum bases which are disposed in the lampshade.

In order to solve the problem, the invention may further adopt the following improved measures:

Recesses for holding tail portions of the aluminum bases are formed in the fixing base; and the aluminum bases are fixed on the recesses of the fixing base through the viscose glue.

The number of the aluminum bases is at least three; the three aluminum bases are mutually encircled to form a hollow lamp post; a top aluminum base is disposed on the top of the lamp post; a positioning post is disposed on the fixing base and extended into a tail portion of the lamp post; various recesses for holding tail portions of corresponding aluminum bases are respectively formed on the circumference of the positioning post; and the aluminum bases are fixed on the recesses of the fixing base through the viscose glue;

or alternatively, the number of the aluminum bases is four; the four aluminum bases are mutually encircled to form a hollow lamp post which is rectangular; a top aluminum base is disposed on the top of the lamp post; a positioning post is disposed on the fixing base and extended into a tail portion of the lamp post; various recesses for holding tail portions of corresponding aluminum bases are respectively formed on the circumference of the positioning post; and the aluminum bases are fixed on the recesses of the fixing base through the viscose glue.

A heat sink is disposed in an inner cavity of the lamp post; and surfaces which respectively correspond to various aluminum bases and are configured to make contact with inner surfaces of corresponding aluminum bases are disposed on the outside of the heat sink.

The inside of the heat sink is hollow.

Pins are disposed on the tail portions of various aluminum bases and inserted into corresponding jacks on the fixing base.

The number of the aluminum bases is at least three; the three aluminum bases are mutually encircled to form a hollow lamp post; a top aluminum base is disposed on the top of the lamp post; a positioning post is disposed on the fixing base and extended into a tail portion of the lamp post; a heat sink is disposed in an inner cavity of the lamp post; surfaces which respectively correspond to various aluminum bases and are configured to make contact with inner surfaces of corresponding aluminum bases are disposed on the outside of the heat sink; and the positioning post is in threaded connection with the heat sink;

or alternatively, the number of the aluminum bases is four; the four aluminum bases are mutually encircled to form a hollow lamp post which is rectangular; a top aluminum base is disposed on the top of the lamp post; a positioning post is disposed on the fixing base and extended into a tail portion of the lamp post; a heat sink is disposed in an inner cavity of the lamp post; surfaces which respectively correspond to various aluminum bases and are configured to make contact with inner surfaces of corresponding aluminum bases are disposed on the outside of the heat sink; and the positioning post is in threaded connection with the heat sink.

Threads are formed at an upper end of the positioning post; screwed holes are formed at the bottom of a lower end of the heat sink; and an upper end of the positioning post is extended into the screwed holes and in threaded connection with the heat sink.

The lampshade is adhesively connected with the open end of the lamp holder through the viscose glue; or alternatively, the lampshade is connected with the open end of the lamp holder through the clamping connection of projections and recesses thereof.

A circuit board is disposed at an inner end of the fixing base.

The technical proposal has the advantages that:

1. The LED lamp bulb provided by the invention has the advantages of stable structure and good positioning as the fixing base is in threaded connection with the internal threads in the lamp holder through the external threads of the fixing base. In addition, the LED lamp bulb provided by the invention is convenient in assembly. Moreover, as the fixing base is directly adhered to the lamp holder via the viscose glue, the LED lamp bulb provided by the invention has the advantages of simple structure and easy assembly.

2. As the LED lamp bulb provided by the invention has a small size, the lamp post can emit light to various directions, and hence the surround illumination can be achieved, and consequently the LED lamp bulb provided by the invention can be very bright.

3. As the positioning post is disposed on the fixing base of the LED lamp bulb provided by the invention and extended into the tail portion of the lamp post and various recesses for holding the tail portions of corresponding aluminum bases are respectively formed on the circumference of the positioning post, the lamp post can be easily positioned during the assembly of the structure, and hence the assembly process can be simpler. Moreover, after the process of bonding via the viscose glue, the connection between the aluminum bases and the fixing base is firmer.

4. In the preferred embodiments, the heat sink is connected with the positioning post and hence the lamp post is sleeved on the heat sink. As the size of the inside of the lamp post is matched with the size of the heat sink, the lamp post is tightened on the heat sink, and hence the fixed connection between the lamp post and the fixing base can be achieved. Therefore, the LED lamp bulb provided by the invention has the advantages of convenient assembly and simple operation.

### BRIEF DESCRIPTION OF THE DRAWINGS

FIG. 1 is an external view of an LED lamp bulb provided by the invention;

FIG. 2 is an exploded view of the LED lamp bulb provided by the invention;

FIG. 3 is an exploded view of the LED lamp bulb provided by the invention in another visual angle;

FIG. 4 is an exploded view f aluminum bases and a fixing base;

FIG. 5 is an exploded view of the fixing base and a lamp holder;

FIG. 6 is an exploded view of a lamp post and a heat sink;

FIG. 7 is an assembly drawing of aluminum bases and a top aluminum base in the lamp post;

FIGS. 8 to 10 are exploded views of another embodiment of the invention in different visual angles; and

FIG. 11 is an exploded view of the lamp holder and the aluminum bases.

### DETAILED DESCRIPTION OF THE PREFERRED EMBODIMENTS

Detailed description will be given below to the invention with reference to the preferred embodiments.

### Embodiment 1

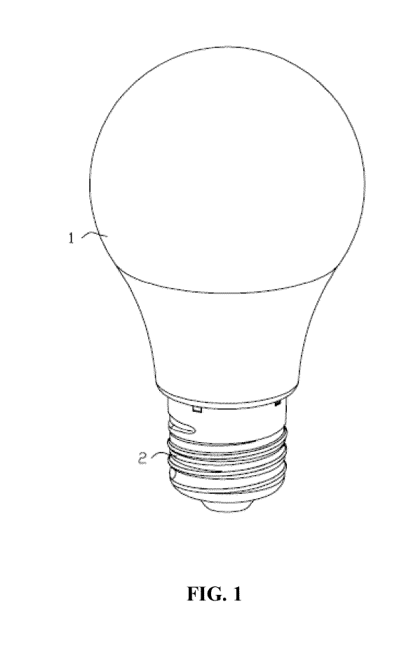

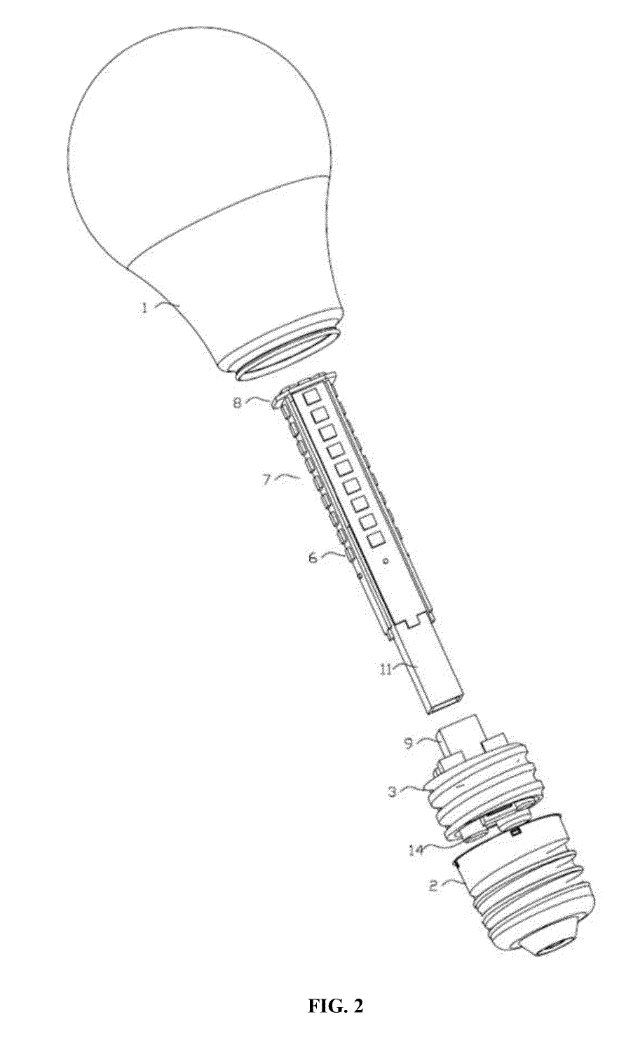

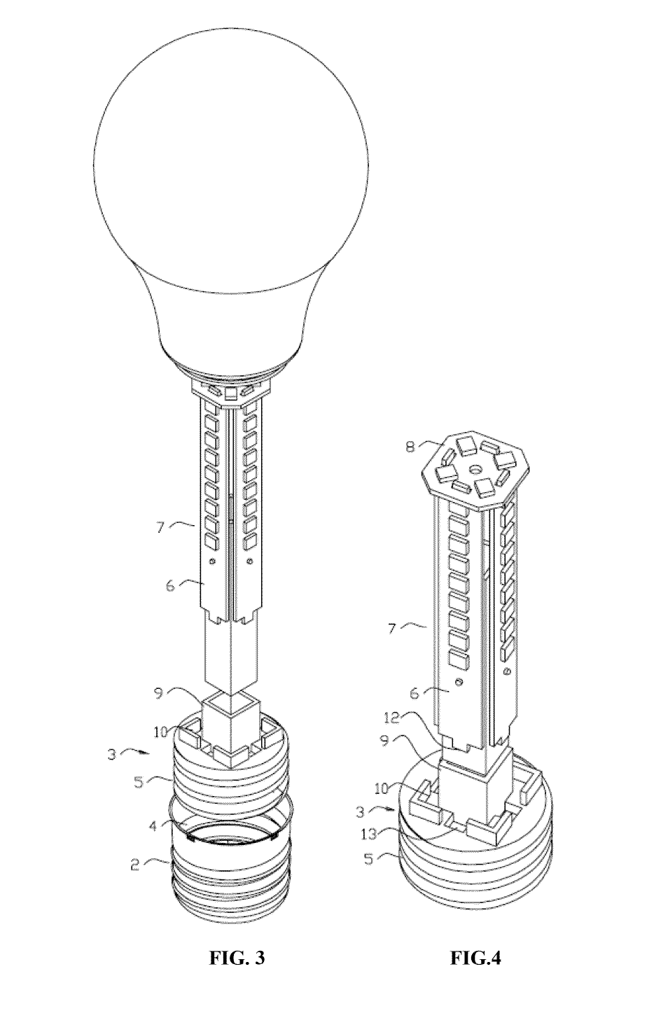

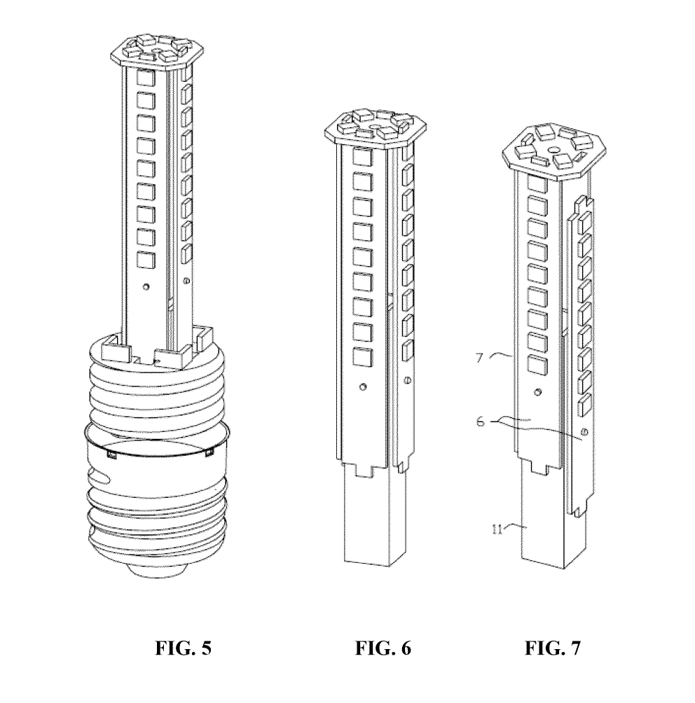

as illustrated in FIGS. 1 to 7, the LED lamp bulb comprises a lampshade 1, a lamp holder 2 and a fixing base 3, wherein the shape of the fixing base made of plastics is matched with the inside of the lamp holder; internal threads 4 are formed in the lamp holder 2; external threads 5 are formed on an outer wall of the fixing base 3; and the fixing base 3 is extended into the lamp holder 2 from an open end of the lamp holder 2, and is in threaded connection with the internal threads 4 in the lamp holder 2 through the external threads 5 of the fixing base 3. Due to the connecting structure, the LED lamp bulb has the advantages of stable and firm connection and good positioning. In addition, the lampshade 1 is connected with the open end of the lamp holder 2. Moreover, the number of aluminum bases 6 is four; the four aluminum bases 6 are mutually encircled to form a hollow lamp post 7 which is rectangular; a top aluminum base 8 is disposed on the top of the lamp post; a positioning post 9 is disposed on the fixing base 3 and extended into a tail portion of the lamp post; various recesses 10 for holding tail portions of corresponding aluminum bases are respectively formed on the circumference of the positioning post 9; the aluminum bases 6 are fixed on the recesses 10 of the fixing base through the viscose glue; LEDs are disposed on the aluminum bases 6; an LED is also disposed on the top aluminum base 8; and the aluminum bases are disposed in the lampshade. In this case, the lamp post has five light-emitting surfaces and can emit light in various directions, and hence the LED lamp bulb is very bright and the surround illumination can be achieved. Moreover, viscose glue is coated between the fixing base and the lamp holder, and hence the connection can be firmer and more stable.

A heat sink 11 is disposed in an inner cavity of the lamp post 7, and surfaces which respectively correspond to various aluminum bases 6 and are configured to make contact with inner surfaces of corresponding aluminum bases are disposed on the outside of the heat sink 11. Therefore, heat transmission can be achieved by the contact. In addition, as the heat sink 11 is disposed in the lamp post 7, not only the heat dissipation can be achieved but also the space can be saved. Moreover, as the heat sink 11 has a small size, the appearance of the lamp bulb cannot be affected, and hence the lamp bulb is beautiful as well. In addition, light emitted by the LED lamp during the light emitting cannot be blocked.

As illustrated in FIG. 4, pins 12 are disposed on the tail portions of various aluminum bases and inserted into corresponding jacks 13 on the fixing base. Moreover, a circuit board 14 is disposed at an inner end of the fixing base.

The positioning post is disposed on the fixing base and extended into the tail portion of the lamp post and various recesses for holding the tail portions of corresponding aluminum bases are respectively formed on the circumference of the positioning post. The aluminum bases are inserted into the recesses at first during the assembly of the structure, so that the lamp post can be easily positioned, and hence the assembly process can be simpler. Moreover, after the process of bonding via the viscose glue, the connection between the aluminum bases and the fixing base can be firmer.

Another improved embodiment: the inside of the heat sink 11 is hollow, which not only is conducive to the heat dissipation but also can save the materials of the heat sink and hence save the cost.

Another embodiment: viscose glue is coated between the fixing base and the lamp holder and the fixing base is directly adhered to the lamp holder; no thread is formed in the lamp holder; and no thread is formed on the outside of the fixing base. The embodiment has the advantages of simple structure, easy assembly and stability.

Another improved embodiment: the number of the aluminum bases is three; the three aluminum bases are mutually encircled to form a hollow lamp post which is prismatic; a top aluminum base is disposed on the top of the lamp post; a positioning post is disposed on the fixing base and extended into a tail portion of the lamp post; various recesses for holding tail portions of corresponding aluminum bases are respectively formed on the circumference of the positioning post; the aluminum bases are fixed on the recesses of the fixing base via the viscose glue; and LEDs are disposed on the aluminum bases which are disposed in the lampshade.

Another improved embodiment: the lampshade is adhesively connected with the open end of the lamp holder through the viscose glue, or alternatively, the lampshade is connected with the open end of the lamp holder by the clamping connection between projections and recesses thereof.

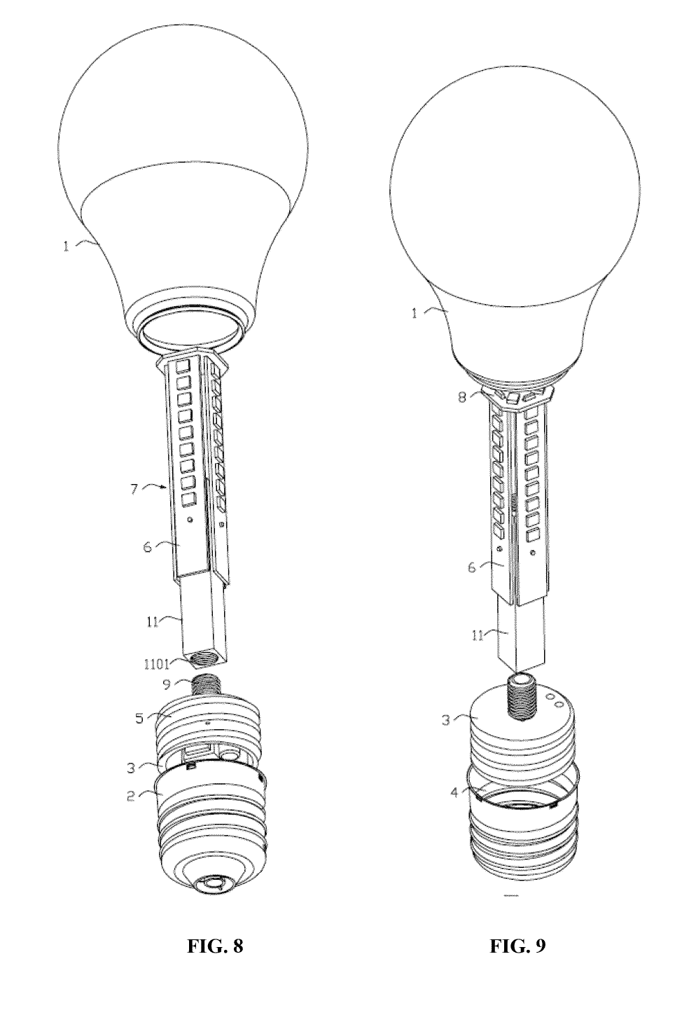

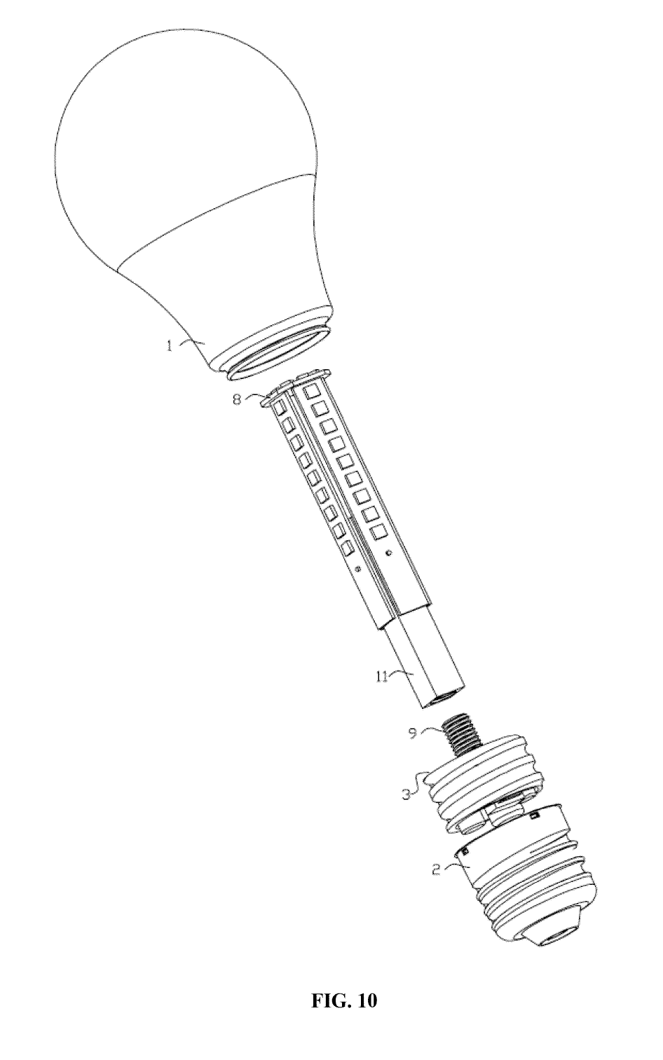

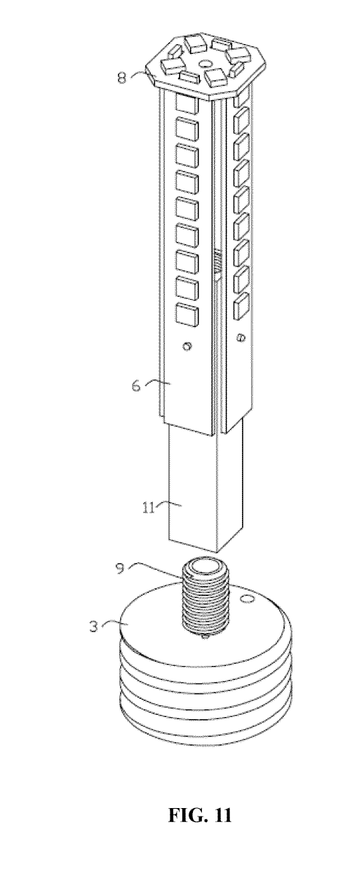

Another improved embodiment: as illustrated in FIGS. 8 to 11, the embodiment has the characteristics that: the LED lamp bulb comprises a lampshade 1, a lamp holder 2 and a fixing base 3, wherein the shape of the fixing base made of plastics is matched with the inside of the lamp holder; internal threads 4 are formed in the lamp holder 2; external threads 5 are formed on an outer wall of the fixing base 3; and the fixing base 3 is extended into the lamp holder 2 from an open end of the lamp holder 2, and is in threaded connection with the internal threads 4 in the lamp holder 2 through the external threads 5 of the fixing base 3. Due to the connecting structure, the LED lamp bulb provided by the invention has the advantages of stable and firm connection and good positioning. In addition, the lampshade 1 is connected with the open end of the lamp holder 2. Moreover, the number of the aluminum bases 6 is four; the four aluminum bases 6 are mutually encircled to form a hollow lamp post 7 which is rectangular; a top aluminum base 8 is disposed on the top of the lamp post and connected with various aluminum bases; a positioning post 9 is disposed on the fixing base 3 and extended into a tail portion of the lamp post 7; a heat sink 11 is disposed in an inner cavity of the lamp post 7; surfaces which respectively correspond to various aluminum bases 6 and are configured to make contact with inner surfaces of corresponding aluminum bases are disposed on the outside of the heat sink 11; the positioning post 9 is in threaded connection with the heat sink 11; threads are formed at an upper end of the positioning post 9; screwed holes 1101 are formed at the bottom of a lower end of the heat sink 11; and the upper end of the positioning post 9 is extended into the screwed holes 1101 and in threaded connection with the heat sink 11. In the embodiment, the heat sink is connected with the positioning post and hence the lamp post is sleeved on the heat sink. As the size of the inside of the lamp post is matched with the size of the heat sink, the lamp post is tightened on the heat sink, and hence the fixed connection between the lamp post and the fixing base can be achieved. Therefore, the LED lamp bulb provided by the invention has the advantages of convenient assembly and simple operation.

Another improved embodiment: the embodiment has the characteristics that: the number of the aluminum bases is at least three; the three aluminum bases are mutually encircled to form a hollow lamp post; a top aluminum base is disposed on the top of the lamp post; a positioning post is disposed on the fixing base and extended into a tail portion of the lamp post; a heat sink is disposed in an inner cavity of the lamp post; surfaces which respectively correspond to various aluminum bases and are configured to make contact with inner surfaces of corresponding aluminum bases are disposed on the outside of the heat sink; and the positioning post is in threaded connection with the heat sink. Moreover, threads are formed at an upper end of the positioning post; screwed holes are formed at the bottom of a lower end of the heat sink; and the upper end of the positioning post is extended into the screwed holes and in threaded connection with the heat sink. Of course, the lamp post may also be formed by more aluminum bases.

As the fixing base is in threaded connection with the internal threads in the lamp holder through the external threads of the fixing base, the LED lamp bulb provided by the invention has the advantages of stable structure and good positioning. In addition, the LED lamp bulb provided by the invention is convenient in assembly. Moreover, as the LED lamp bulb provided by the invention has a small size, the lamp post can emit light in various directions, and hence the surround illumination can be achieved, and consequently the LED lamp bulb provided by the invention is relatively bright.

The foregoing is only the preferred embodiments of the invention and not intended to limit the scope of protection of the invention. Any change or replacement which can be easily thought by those skilled in the art after the disclosure of the invention should fall within the scope of protection of the invention. Therefore, the scope of protection of the invention should be defined by the appended claims.

What is claimed is:

1. A light-emitting diode (LED) lamp bulb, comprising a lampshade, a lamp holder and a fixing base, wherein the shape of the fixing base made of plastics is matched with the inside of the lamp holder; internal threads are formed in the lamp holder; external threads are formed on an outer wall of the fixing base; the fixing base is extended into the lamp holder from an open end of the lamp holder; the fixing base is in threaded connection with the internal threads in the lamp holder through the external threads of the fixing base, or alternatively, viscose glue is coated between the fixing base and the lamp holder and the fixing base is directly adhered to the lamp holder; the lampshade is connected with the open end of the lamp holder; aluminum bases are fixed on the fixing base; and LEDs are disposed on the aluminum bases which are disposed in the lampshade.

2. The LED lamp bulb according to claim 1, wherein recesses for holding tail portions of the aluminum bases are formed in the fixing base; and the aluminum bases are fixed on the recesses of the fixing base through the viscose glue.

3. The LED lamp bulb according to claim 2, wherein the number of the aluminum bases is at least three; the three aluminum bases are mutually encircled to form a hollow lamp post; a top aluminum base is disposed on the top of the lamp post; a positioning post is disposed on the fixing base and extended into a tail portion of the lamp post; various recesses for holding tail portions of corresponding aluminum bases are respectively formed on the circumference of the positioning post; and the aluminum bases are fixed on the recesses of the fixing base through the viscose glue;
or alternatively, the number of the aluminum bases is four; the four aluminum bases are mutually encircled to form a hollow lamp post which is rectangular; a top aluminum base is disposed on the top of the lamp post; a positioning post is disposed on the fixing base and extended into a tail portion of the lamp post; various recesses for holding tail portions of corresponding aluminum bases are respectively formed on the circumference of the positioning post; and the aluminum bases are fixed on the recesses of the fixing base through the viscose glue.

4. The LED lamp bulb according to claim 3, wherein a heat sink is disposed in an inner cavity of the lamp post; and surfaces which respectively correspond to various aluminum bases and are configured to make contact with inner surfaces of corresponding aluminum bases are disposed on the outside of the heat sink.

5. The LED lamp bulb according to claim 4, wherein the inside of the heat sink is hollow.

6. The LED lamp bulb according to claim 3, wherein pins are disposed on the tail portions of various aluminum bases and inserted into corresponding jacks on the fixing base.

7. The LED lamp bulb according to claim 1, wherein the number of the aluminum bases is at least three; the three aluminum bases are mutually encircled to form a hollow lamp post; a top aluminum base is disposed on the top of the lamp post; a positioning post is disposed on the fixing base and extended into a tail portion of the lamp post; a heat sink is disposed in an inner cavity of the lamp post; surfaces which respectively correspond to various aluminum bases and are configured to make contact with inner surfaces of corresponding aluminum bases are disposed on the outside of the heat sink; and the positioning post is in threaded connection with the heat sink;
or alternatively, the number of the aluminum bases is four; the four aluminum bases are mutually encircled to form a hollow lamp post which is rectangular; a top aluminum base is disposed on the top of the lamp post; a positioning post is disposed on the fixing base and extended into a tail portion of the lamp post; a heat sink is disposed in an inner cavity of the lamp post; surfaces which respectively correspond to various aluminum bases and are configured to make contact with inner surfaces of corresponding aluminum bases are disposed on the outside of the heat sink; and the positioning post is in threaded connection with the heat sink.

8. The LED lamp bulb according to claim 7, wherein threads are formed at an upper end of the positioning post; screwed holes are formed at the bottom of a lower end of the heat sink; and an upper end of the positioning post is extended into the screwed holes and in threaded connection with the heat sink.

9. The LED lamp bulb according to claim 1, wherein the lampshade is adhesively connected with the open end of the lamp holder through the viscose glue; or alternatively, the lampshade is connected with the open end of the lamp holder through the clamping connection of projections and recesses thereof.

10. The LED lamp bulb according to claim 1, wherein a circuit board is disposed at an inner end of the fixing base.
